(19) United States
(12) Patent Application Publication
(10) Pub. No.: US 2019/0202067 A1
(43) Pub. Date: Jul. 4, 2019

(54) METHOD AND DEVICE FOR LOCALIZING ROBOT AND ROBOT

(71) Applicant: UBTECH Robotics Corp, Shenzhen (CN)

(72) Inventors: Youjun Xiong, Shenzhen (CN); Gaobo Huang, Shenzhen (CN); Musen Zhang, Shenzhen (CN); Xiangbin Huang, Shenzhen (CN)

(21) Appl. No.: 16/214,155

(22) Filed: Dec. 10, 2018

(30) Foreign Application Priority Data
Dec. 28, 2017 (CN) 201711472785.2

(51) Int. Cl. B25J 13/08; B25J 13/00; B25J 19/02; B25J 9/16; G06K 9/62

(52) U.S. Cl. CPC B25J 13/089; B25J 13/006; G06K 9/629; B25J 9/1697; B25J 19/022

(57) ABSTRACT

A computer-implemented method for localizing a robot comprising an ultra wideband (UWB) localization device, at least one sensor and a particle filter localization device. The method comprising executing on a processor steps of: acquiring first location information of the robot through the UWB localization device; acquiring second location information within a range defined by the first location information through the at least one sensor, wherein the second location information comprising current location information and running orientation data of the robot; and determining, by the particle filter localization device, whether there exists a localization point matching the second location information in data of a preset map; if so, determining that the second location information is valid location information of the robot.

### CROSS REFERENCE TO RELATED APPLICATIONS

This application claims priority to Chinese Patent Application No. 201711472785.2, filed Dec. 28, 2017, which is hereby incorporated by reference herein as if set forth in its entirety.

### BACKGROUND

### 1. Technical Field

The present disclosure generally relates lo robots, and particularly to a method for localizing a robot.

### 2. Description of Related Art

As technology advances, service robots are becoming more common. A service robot is usually required to accurately determine its location to fulfill its mission efficiently in various environments.

For those robots supporting map navigation function, they need to localize themselves before the map navigation starts so that the coordinate information and the orientation information of their current locations can be obtained. One problem with some of such robots is that the starting of the localization without the approximate information of their current locations tends to cause a delay or localization error.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG 1 is a flow chart of a method for localizing a robot according to an embodiment.

FIG. 2 shows an exemplary schematic scenario of the working environment of the robot.

FIG. 3 is a schematic block diagram of a robot according to an embodiment.

FIG. 4 is a schematic block diagram of a robot according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

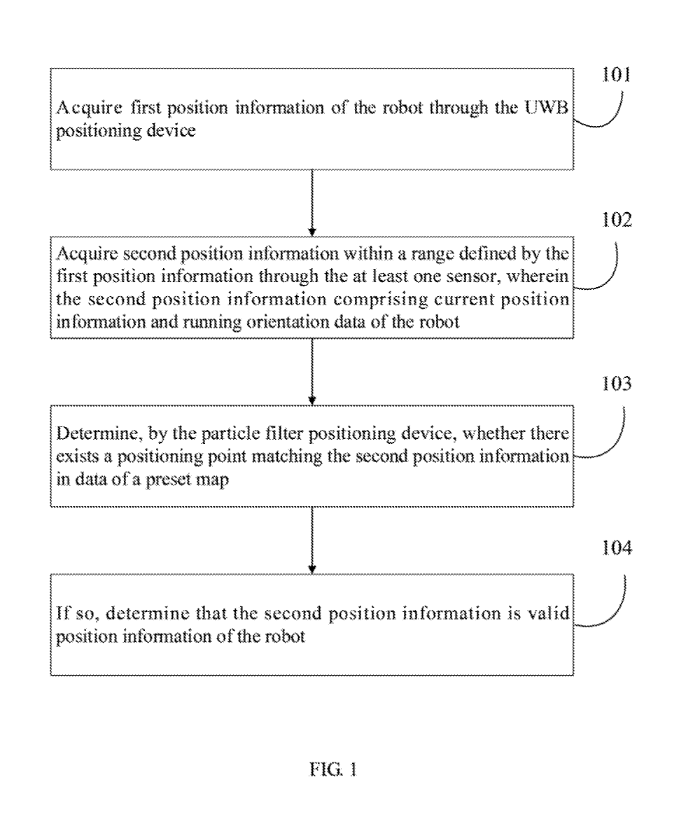

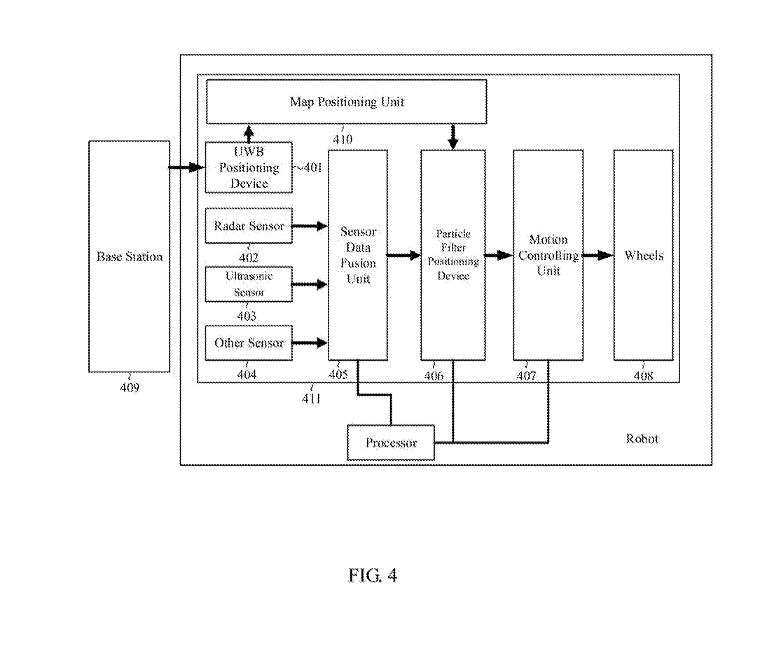

FIG. 1 is a flow chart of a method for localizing a robot according to one embodiment. In one embodiment, as shown in FIG. 4, the robot includes a localization device including one or more processors, a storage, an ultra wideband (UWB) localization device, at least one sensor and a particle filter localization device. One or more computer programs are stored m the storage and executable by the one or more processors to implement the method for localizing a robot. The robot can be an indoor service robot, a household robot such as a cleaning robot, or an industrial robot. The method includes the following steps:

Step S101: acquiring first location information of the robot through the UWB localization device.

The UWB localization device wirelessly transmits data using nanosecond non-positive-spinning narrow pulses. It transmits signals in a high-bandwidth, fast-pulse manner with good penetration. In the embodiment, the UWB localization device is mounted on the robot for transmitting localization signals. The UWB localization device can be selected from UWB tags, UWB chips, UWB transmitters or other devices capable of transmitting narrow pulses to transmit data, which is required to obtain the localization information within the accuracy set by the robot, i.e. the first location information, such as the information of the current coordinate of the robot with respect to the origin of a preset map.

In the embodiment, the UWB localization device adopt a time difference of arrival (TDOA) localization principle to determine the location of the robot relative to various base stations. The distance between the robot and a base station is determined by multiplying the wireless signal transmission time by the wireless signal transmission speed. Specifically, the UWB localization device first transmits the localization signal to a number of base stations, and then acquires a time when each of the base stations receives the localization signal from the UWB localization device. Time differences of arrival among the signals received by the base stations are determined. The difference in distances between the robot and the base stations can then be determined. The first location information can then be determined based on the difference in distances, finding location with time difference of arrival is well known and will not be described in detail.

Since the first location information is only the information of the coordinate of the robot relative to the origin of the preset map, and a preliminary localization only requires a small amount of location information, the minimum number of base stations is three. If a more accurate first location information is needed, the number of base stations may be increased, such as four, five, seven, etc. In theory, the more the number of base stations is, the more accurate the localizing accuracy will be. In view of the cost, preferably, four base stations are employed. The base stations in the embodiment are UWB base stations corresponding to the UWB localization devices, and only needs to receive and analyze the localization signals sent by the UWB localization devices. Thus, the base stations in the embodiment may be localization sensors arranged according to actual conditions.

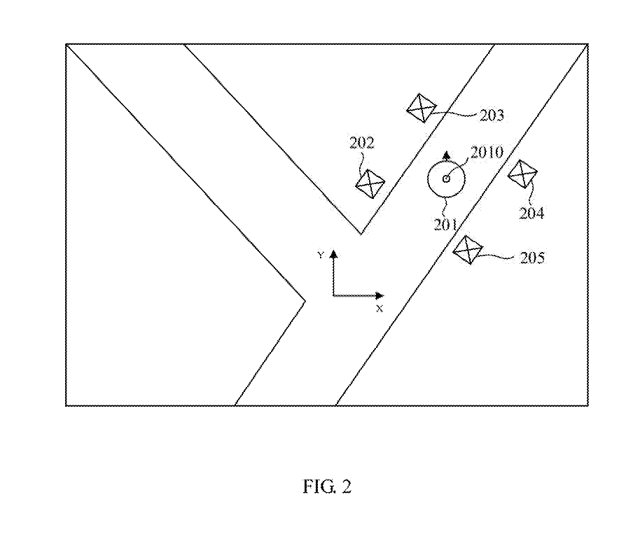

FIG. 2 shows an exemplary schematic scenario of the working environment of the robot. In the scenario, the robot is an indoor service robot and four base stations are employed. As shown in FIG. 2, the robot 201 is moving in the direction indicated by the arrow, and the four blocks 202, 203, 204 and 205 are base stations arranged on the ceiling. The circle in the robot 201 represents the UWB localization device 2010, and the UWB localization device 2010 transmits a localization signal to any three of the four base stations. After receiving the localization signal, the base stations send a signal to a central processing unit through a cable. The central processing unit then determines the difference in distances between the UWB localization device 2010 and the base stations 202, 203, 204 and 205, and obtains the first location information of the robot 201 based on the difference in location between the four base stations. The first location is the information of the current coordinate of the robot with respect to the origin of a preset map. If further determination of other location informal ion of the robot 201 is required, the calculation may be changed with the inclusion of other location information about the UWB localization device 2010.

In another embodiment, the first location information can be determined based on a different TDOA localization principle. Specifically, base stations transmit localization signals, and the UWB localization device receives the localization signals, which simultaneously realizes tracking localization and navigation localization. More specifically, each base station sends a localization signal to the UWB localization device, and the UWB localization device sends a feedback signal in response to the localization signal to each base station. The differences in distance between each base station and the UWB localization device are then calculated according to the time when the feedback signals are received, thereby determining the first location information so as to provide cost-optimized solutions according to different application scenarios.

In yet another embodiment, the difference in distance can also be determined based on the received signal strength of the base station. Specifically, the initial strength of the localization signal transmitted by the UWB localization device is constant, but the strength of the signal is attenuated during transmission. The distance between each base station and the robot can be estimated based on the strength of the received signal and a known signal attenuation model. The received signal strength is measured by Received Signal Strength Indication (RSSI). A number of circles can be drawn according to the distances between base stations and the robot. The location of the robot is within the overlapping areas of the circles. The number of base stations can be selected based on the desired accuracy of the first location information.

In order to quickly determine the location of the robot, since in this embodiment only the ultra-wideband UWB localization device is used to determine the approximate location of the robot, the location of the robot can be determined according to the angle of the received signal of the base stations. Specifically, the source direction of the localization signal transmitted by the UWB localization device can be detected by the directional antenna of the base stations and a number of straight lines that connect the robot and each of the base stations can be drawn based on the angles of the received signal. The intersection point of the straight lines is the location of the robot.

In other embodiments, the number of base stations may be increased or decreased according to lest mode and the desired calculation accuracy.

Step S102: acquiring second location information within a range defined by the first location information through the at least one sensor, wherein the second location information comprising current location information and running orientation data of the robot.

In the embodiment, radar data and ultrasonic data of the robot within the range defined by the first location information are acquired through the at least one sensor. The radar data and the ultrasound data include read surface feature information and orientation information within the range defined by the first location information. A fusion calculation based on the ultrasound data and the radar data is then performed to obtain the second locution information of the robot within the range defined by me first location information.

In order to determine the second location information more accurately, infrared data and image data are also needed. A fusion calculation based on the ultrasonic data, the radar data, the infrared data and the image data is performed to obtain the second location information of the robot within the range defined by the first location information. The radar data, the ultrasound data, the infrared data and the image data include road surface feature information and orientation information within the range defined by the first location information. Specifically, after the first location information is acquired, in order lo determine the direction information of the robot, the robot will move and rotate so that the radar data, the ultrasound data, the infrared data and the image data within the range defined by the first location information can be obtained through the at least one sensor. A fusion calculation based on the ultrasonic data, the radar data, the infrared data and the image data is then performed to obtain the second location information of the robot within the range defined by the first location information. The radar data, the ultrasound data, the infrared data and the image data include information within the range defined by the first location information, such as the width of the road, the existence/nonexistence of obstacles, and the extending direction of the road. During the movement and rotation of the robot, whether an obstacle is existed in the current extending direction is determined based on the output of the at least one sensor. If an obstacle is existed in the current moving direction, the robot is controlled to move toward a direction in which no obstacles arc existed,

Step S103: determining, by the particle filter localization device, whether there exists a localization point matching the second location information in data of a preset map.

Particle filter localization, also called adaptive Monte Carlo localization (AMCL), is to locate points based on the acquired map data and scan features. Specifically, the process is as follows: determining, by the particle filter localization device, whether there exists in the data of the preset map a matching point whose degree of matching with the second location information is greater than a preset value; if so. determining that there exists a localization point matching the second location information in the data of the preset map. In this case, the second location information is valid location information of the robot.

After acquiring the second location information, the second location information including the radar data, the ultrasound data, the infrared data, and the image data is subscribed by the particle filter localization device. The second location information is then compared with the location information and the orientation information of each localization point of the preset map data so as to determine whether there exists a localization point matching the second location information in the preset map data. That is, the location and orientation of the robot are compared with each localization point of the data, within the range defined by the first location information, of the preset map. In the embodiment, each localization point of the preset map data is obtained by partitioning the preset map in advance.

In another embodiment, whether there exists a localization point matching the second location information in data of a preset map can be determined based on Monte Carlo localization (MCL) method. Specifically, first, particles are uniformly laid in the first location information. After the robot starts to move, it can cause the location of the corresponding particles to change. But in the calculation process, it is assumed that the movement of the robot drives all particles to move. The information simulated by the location of each particle is matched with the second location information, thereby assigning each particle probability. The particles are then regenerated based on the generated probability, and the higher the probability, the greater the probability of generation. After iteration, all the particles will converge together to determine the exact location of the robot. Other localization methods can also be used according to need.

Step S104: determining that the second location information is valid location information of the robot if there exists a localization point matching the second location information in data of a preset map.

In the embodiment, if there exists a localization point matching the second location information in data of a preset map (the degree of matching is greater than 70%), the second location information is determined to be valid location information of the robot, which means that the localization of the robot is successful, if there does not exist a localization point matching the second location information in data of a preset map (the degree of matching is less than 70%), steps S101 through S103 will be repeated till the localization of the robot is successful. The degree of matching in the embodiment may be adjusted to 50%. 60%, 70% and 80% according to need.

With the method including the above steps, localization accuracy and speed are significantly improved, which results in an improved user experience.

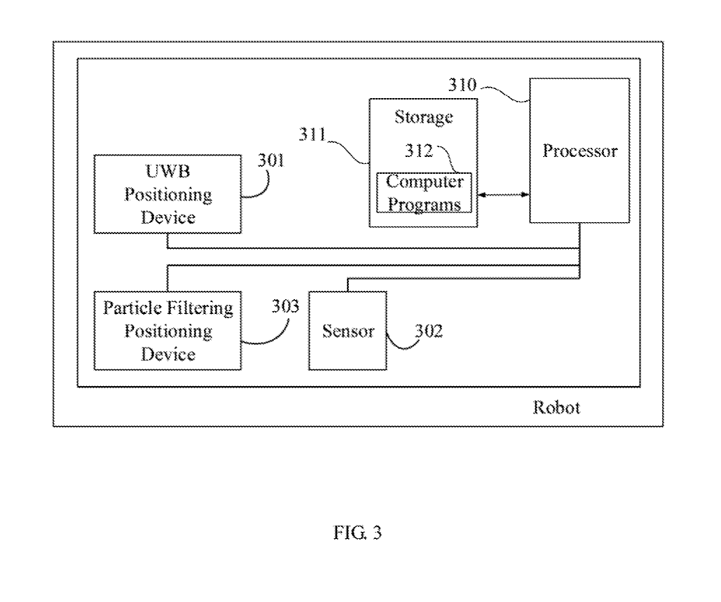

Referring to FIG. 3, in one embodiment, a device for a robot includes a UWB localization device 301, a sensor 302 and particle filtering localization device 303. The UWB localization device 301 is used to obtain first location information of the robot. The sensor 302 is used to obtain second location information within a range defined by the first location information. The second location information includes current location information and running orientation data of the robot. The sensor 302 can be a radar sensor, an ultrasonic sensor or a combination thereof. The particle filtering localization device 303 is used to determine whether there exists a localisation point matching the second location information in data of a preset map and determine that the second location information is valid location information of the robot when the localization point exists.

After the robot receives a localizing command, the UWB localization device 301 transmits a localization signal to base stations. Time differences of arrival among the localization signals received by the base stations can then be determined and the difference in distances between the UWB localization device 301 and the base stations can then be determined. The first location information can then be determined based on the difference in distances. After the first location information is obtained, the robot is controlled to move so that the sensor 302 can obtain the second location information. The particle filtering localization device 303 then determines whether there exists a localization point matching the second location information in data of a preset map and determines that the second location information is valid location information of the robot when the localization point exists (e.g. when the degree of matching is greater than 70%). which means that the localization of the robot is successful. If there does not exist a localization point matching the second location information in data of a preset map (the degree of matching is less than 70%), the UWB localization device 301, the sensor 302 and the particle filtering localization device 303 then controlled to repeat the actions as stated above till the localization of the robot is successful.

The device further includes a processor 310, a storage 311, one or more computer programs 312 stored in the storage 311 and executable by the processor 310. When the processor 310 executes the computer programs 312, steps S101 to S104 shown in FIG. 1 are implemented, and the UWB localization device 301, the sensor 302 and the particle filtering localization device 303 are controlled to operate as stated above.

The processor 310 may be a central processing unit (CPU), a general-purpose processor, a digital signal processor (DSP), an application specific integrated circuit (ASIC), a Field-Programmable Gate Array (FPGA), a programmable logic device, a discrete gate, a transistor logic device, or a discrete hardware component. The general purpose processor may be a microprocessor or any conventional procesesor or the like.

The storage 311 may be an internal storage unit, such as a hard disk or a memory. The storage 311 may also be an external storage device, such as a plug-in hard disk, a smart memory card (SMC), and a Secure Digital (SD) card, or any suitable flash card. Farther, the storage 311 may also include both an internal storage unit and an external storage device. The storage 311 is used to store the computer programs and other programs and data required by the robot. The storage 311 can also be used to temporarily store data that has been output or is about to be output.

With such configuration, the device can significantly improve the localization accuracy and speed, which results in an improved user experience.

Referring to FIG. 4, in an alternative embodiment, a device 411 for a robot includes a UWB localisation device 401, a radar sensor 402, an ultrasonic sensor 403, a sensor data fusion unit 405, a particle filtering localization device 406, a motion containing unit 407, other sensor 404 and a number of wheels 408. The UWB localization device 401 is used to send a localization signal to the base stations 409. The radar sensor 402 is used to obtain radar data of the robot. The ultrasonic sensor 403 is used to obtain ultrasonic data of the robot. The sensor 404 includes an infrared sensor and an imaging sensor and is used to obtain infrared data and image data of the robot.

The sensor data fusion unit 405 is used to fuse radar data, ultrasound data, infrared data, and image data, and the motion controlling unit 407 is used to control the movement and rotation of the robot. The particle littering localization device 406 is used to determine whether there exists a localization point matching the second location information in data of a preset map and determine that the second location information is valid location information of the robot when the localization point exists.

After the robot receives a localizing command, the UWB localization device 401 sends a localization signal to the base stations 409. Time differences of arrival among the localization signals received by the base stations 409 can then be determined and the difference in distances between the UWB localization device 401 and the base stations 409 can then be determined. The first Location information can then be determined based on the difference in distances. Alter the first location information is obtained, the UWB localization device 401 sends the first location information to the particle filtering localization device 406. The wheels 408 is then controlled to rotate the radar sensor 402, an ultrasonic sensor 403, the infrared sensor and the imaging sensor are then controlled to respectively obtain radar data, ultrasonic data, infrared data and image data of the robot within a range defined by the first location information. A fusion calculation based on the ultrasonic data, the radar data, the infrared data and the image data is then performed to obtain the second location information of the robot. The particle filtering localization device 406 then determines whether there exists a localization point matching the second location information in data of a preset map and determines that the second location information is valid location information of the robot when the localization point exists (e.g. when the degree of matching is greater than 70%), which means that the localization of the robot is successful. If there does not exist a localization point matching the second location information in data of a preset map (the degree of matching is less than 70%), the above components of the device 411 are then controlled to repeat the actions as stated above till the localization of the robot is successful.

With such configuration, the device 411 can significantly improve the localization accuracy and speed, which results in an improved user experience.

Different from the embodiment of FIG. 3, the embodiment of FIG. 4 includes more sensors and the second location information can be determined more accurately, which improves the matching accuracy.

Although the features and elements of the present disclosure are described as embodiments in particular combinations, each feature or clement can be used alone or in other various combinations within the principles of the present disclosure to the full extent indicated by the broad general meaning of the terms in which the appended claims are expressed.

What is claimed is:

1. A computer-implemented method for localizing a robot comprising an ultra wideband (UWB) localization device, at least one sensor and a particle filter localization device, the method comprising executing on a processor steps of:
acquiring first location information of the robot through the UWB localization device;
acquiring second location information within a range defined by the first location information through the at least one sensor, wherein the second location information comprising current location information and running orientation data of the robot; and determining, by the particle filter localization device, whether there exists a localization point matching the second location information in data of a preset map; if so, determining that the second location information is valid location information of the robot

2. The method according to claim 1, wherein the step of acquiring second location information within a range defined by the first location information through the at least one sensor comprises: acquiring, through the at least one sensor, radar data and ultrasonic data of the robot within the range defined by the first location information, wherein the radar data and the ultrasound data comprises road surface feature information and orientation information within the range defined by the first location information; and
performing a fusion calculation based on the ultrasound data and the radar data to obtain the second location information of the robot within the range defined by the first location information.

3. The method according to claim 1, wherein the step of acquiring second location information within a range defined by the first location information through the at least one sensor comprises:
acquiring, through the at least one sensor, radar data, ultrasonic data, infrared data and image data of the robot within the range defined by the first location information, wherein the radar data, the ultrasonic data, the infrared data and the image data comprises road surface feature information and orientation information within the range defined by the first location information: and
performing a fusion calculation based on the radar data, the ultrasonic data, the infrared data and the image data to obtain the second location information of the robot within the range defined by the first location information.

4. The method according to claim 1, wherein the step of determining, by the particle filter localization device, whether there exists a localization point matching the second location information in data of a preset map comprises:
determining, by the particle filter localization device, whether there exists in the data of the preset map a matching point whose degree of matching with the second location information is greater than a preset value;
if so, determining that there exists a localization point matching the second location information in the data of the preset map.

5. The method according to claim 4, wherein the degree of matching is 70%.

6. The method according to claim 1, wherein the step of determining, by the particle filter localization device, whether there exists a localization point matching the second location information in data of a preset map comprises:
comparing, by the particle filter localization device, the second location information with location information and orientation information of each localization point in data of the preset map, to determine if one of the localization points matches the second location information.

7. The method according to claim 1, wherein the step of acquiring first location information of the robot through the UWB localization device comprises:
transmitting a localization signal of the UWB localization device to a plurality of base stations, and acquiring a lime when each of the base stations receives the localization signal from the UWB localization device: and
calculating lime differences of arrival among the signals received by the plurality of base stations, and determining the first location information of the robot based on the time differences and location coordinates of the plurality of base stations.

8. The method according to claim 7, wherein a number of the base stations is three.

9. The method according to claim 1, wherein the first location information is information of coordinate of the robot with respect to an origin of coordinate of a preset map.

10. A device for localizing a robot comprising an ultra wideband (UWB) localization device, at least one sensor and a particle tiller localization device, the device comprising:
one or more processors;
a storage; and
one or more computer programs stored in (he storage and configured to be executed by the one or more processors, and the one or more computer programs controlling the device to:
acquire first location information of the robot through the UWB localisation device; acquire second location information within a range defined by the first location information through the at least one sensor, wherein the second location information comprising current location information and running orientation data of the robot; and
determine, by the particle filler localization device, whether there exists a localization point matching the second location information in data of a preset map; if so, determine that the second location information is valid location information of the robot.

11. A robot comprising: an ultra wideband (UWB) localization device, al least one sensor and a particle filter localization device;
one or more processors;
a storage; and
one or more computer programs stored in the storage and configured to be executed by the one or more processors, and the one or more computer programs comprising:
instructions for acquiring first location information of the robot through the UWB localization device:
instructions for acquiring second location information within a range defined by the first location information through the at least one sensor, wherein the second location information comprising current location information and running orientation data of the robot; and
instructions for determining, by the particle filler localization device, whether there exists a localization point matching the second location information in data of a preset map; and if so, determining that the second location information is valid location information of the robot.

12. The robot according to claim 11, wherein the instructions for acquiring second location information within a range defined by the first location information through the at least one sensor comprises:
instructions for acquiring, through the at least one sensor, radar data and ultrasonic data of the robot within the range defined by the first location information, wherein the radar data and the ultrasound data comprises road surface feature information and orientation information within the range defined by the first location information; and
instructions for performing a fusion calculation based on the ultrasound data and the radar data to obtain the second location information of the robot within the range defined by the first location information.

13. The robot according to claim 11, wherein the instructions for acquiring second location information within a range defined by the first location information through the at least one sensor comprises:
instructions for acquiring, through the at least one sensor, radar data, ultrasonic data, infrared data and image data of the robot within the range defined by the first location information, wherein the radar data, the ultrasonic data, the infrared data and the image data comprises road surface feature information and orientation information within the range defined by the first location information; and
instructions for performing a fusion calculation based on the radar data, the ultrasonic data, the infrared data and the image data to obtain the second location information of the robot within the range defined by the first location information.

14. The robot according to claim 11, wherein the instructions for determining, by the particle filter localization device, whether there exists a localization point matching the second location information in data of a preset map comprises:
instructions for determining, by the particle filter localization device, whether there exists in the data of the preset map a matching point whose degree of matching with the second location information is greater than a preset value; and if so, determining that there exists a localization point matching the second location information in the data of the preset map.

15. The robot according to claim 11, wherein instructions for determining, by the particle filter localization device, whether there exists a localization point matching the second location information in data of a preset map comprises:
instructions for comparing, by the particle filter localization device, the second location information with location information and orientation information of each localization point in data of the preset map, to determine if one of the localization points matches the second location information.

16. The robot according to claim 11, wherein the instruction for acquiring first location information of the robot through the UWB localization device comprises:
instructions for transmitting a localization signal of the UWB localization device to a plurality of base stations, and acquiring a time when each of the base stations receives the localization signal from the UWB localization device; and
instructions for calculating time differences of arrival among the signals received by the plurality of base stations, and determining the first location information of the robot based on the time differences and location coordinates of the plurality of base stations.

17. The robot according to claim 16, wherein a number of the base stations is three.

18. The robot according to claim 11, wherein the first location information is information of coordinate of the robot with respect to an origin of coordinate of a preset map.
